(19) United States
(12) Patent Application Publication
(10) Pub. No.: US 2009/0310847 A1
(43) Pub. Date: Dec. 17, 2009

(54) MEDICAL IMAGE PROCESSING APPARATUS AND X-RAY DIAGNOSIS APPARATUS

(76) Inventors: Takeo Matsuzaki, Nasushiobara-shi (JP); Yoshiyasu Hayashi, Nasushiobara-shi (JP); Takuya Sakaguchi, Shioya-gun (JP); Masayuki Nishiki, Otawara-shi (JP); Toshiyuki Sato, Nasushiobara-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/547,518

(22) Filed: Aug. 26, 2009

Related U.S. Application Data
(63) Continuation of application No. PCT/JP09/56007, filed on Mar. 25, 2009.

(30) Foreign Application Priority Data
Mar. 25, 2008 (JP) 2008-077405
Jul. 30, 2008 (JP) 2008-196178

(51) Int. Cl. G06K 9/00

(52) U.S. Cl. 382/132; 382/128

(57) ABSTRACT

A medical image processing apparatus includes an image storage unit which stores the data of a three-dimensional image associated with an object receiving an operation using a lumen insertion device, a lumen detection unit which detects a lumen centerline associated with a specific lumen from the three-dimensional image, a current position specifying unit which specifies the current position of the lumen insertion device based on the insertion distance from a reference position associated with the lumen insertion device and the detected lumen centerline, a cross-sectional image generating unit which creates, from the data of the three-dimensional image, the data of a cross-sectional image associated with a cross-section passing through at least one of the current position and an expected insertion position located ahead of the current position, and a display unit which displays the generated data of the cross-sectional image.

### CROSS-REFERENCE TO RELATED APPLICATIONS

This is a Continuation Application of PCT Application No. PCT/JP2009/056007, filed Mar. 25, 2009, which was published under PCT Article 21(2) in Japanese.

This application is based upon and claims the benefit of priority from prior Japanese Patent Applications No. 2008-077405, filed Mar. 25, 2008; and No. 2008-196178, filed Jul. 30, 2008, the entire contents of both of which are incorporated herein by reference.

### BACKGROUND OF THE INVENTION

1. Field of the Invention

The present invention relates to a medical image processing apparatus and X-ray diagnosis apparatus suitable for supporting catheterization.

2. Description of the Related Art

Recently, as a medical treatment for a coronary artery disease, a PCI (Percutaneous Coronary Intervention) treatment has been often performed, in which when a catheter is inserted into an aorta and reaches an impairment, a medical treatment is performed. In this PCI treatment, an operator inserts a catheter while checking the position of the distal end of the catheter under fluoroscopy.

In addition, in a medical treatment for a coronary artery disease, in general, coronary angiography examination is performed by a CT, and a lesion is checked by using a CPR (Curved Planar Reconstruction) image, SPR (Stretched Curved Planar Reconstruction) image, MIP image (Maximum/minimum Intensity Projection), cross-cut image, fly-through image, and the like. In this case, a CPR image is an image two-dimensionally depicting the run of a specific blood vessel. An SPR image is an image in which a line along a blood vessel (e.g., a blood vessel core line) in a CPR image is expressed in a stretched straight form. An MIP image is an image obtained by projection processing of a three-dimensional image. In this image, the maximum value (or minimum value) of a pixel in the projection direction is set as a pixel value of a projection image. A cross-cut image is a cross-sectional image of a cross-sectional plane perpendicular to a blood vessel. In addition, a fly-through image expresses how a blood vessel looks like along its direction from a given point in the blood vessel. Under the circumstances, in a PCI treatment, for more accurate medical treatments, medical treatments have been increasingly performed by referring to such medical images including CPR, SPR, cross-cut, and fly-through images.

More specifically, medical images reconstructed by a medical diagnosis apparatus such as a CT, MRI, or 3D (three-dimensional) angiography apparatus are stored in advance. When performing a PCI treatment, an operator such as a doctor acquires stored medical images and performs angiography and, for example, balloon angioplasty or stent indwelling under X-ray fluoroscopy while referring to the medical images.

In order to refer to these medical images used for medical treatment support, an operator such as a doctor needs to check the approximate position of a catheter during a medical treatment by referring to a fluoroscopic image displayed on an X-ray fluoroscopic monitor and to designate the display position of a medical image corresponding to the approximate position with a mouse or the like. A method of making an operator or the like manually display a medical image based on its approximate position by himself/herself greatly depends on the experience of the operator whether he/she can quickly and properly display medical images used for medical treatment support. That is, the medical treatment time and accuracy vary for each operator.

Conventionally, as techniques of accurately grasping the position of the distal end of a catheter, there have been proposed a technique of embedding a chip in the distal end of a catheter and detecting the position of the chip by an external position detecting device (see Jpn. Pat. Appln. KOKAI Publication No. 2000-342580) and a technique of attaching a plurality of markers to an object to be examined and calculating the coordinates of a catheter from the relationship between the positions of the markers and the position of the catheter (see Jpn. Pat. Appln. KOKAI Publication No. 2003-305032).

Either of the techniques disclosed in these references requires a large, complicated apparatus to grasp the position of a catheter. Consequently, an apparatus to obtain images to be referred to by using such position detection is inevitably a large, complicated apparatus. That is, it is too expensive to arrange an apparatus configured to simply display a medical image of a portion corresponding to an affected part so as to support a medical treatment.

A medical treatment method called an intravascular treatment has been rapidly prevailing lately because it can obtain a curative effect with low invasiveness by inserting a catheter or a guide wire (to be referred to as a wire hereinafter) into a blood vessel and treating an affected part with the catheter. As an X-ray diagnosis apparatus used for such a vascular treatment method, a technique of displaying a two-dimensional image of a blood vessel or the like of an object to be examined in real time has been proposed (see, for example, Jpn. Pat. Appln. KOKAI Publication No. 2006-34952). There is available a technique of performing a medical treatment by inserting a catheter or a catheter such as a guide wire into a blood vessel while referring to a two-dimensional projection image using such an X-ray image diagnosis apparatus.

The above technique, however, has the following problem. Using only two-dimensional projection images makes it impossible to accurately check information of an object to be examined in the depth direction such as the thickness of a blood vessel wall and a state in the thickness direction in a blood vessel, which are required for a medical treatment and diagnosis. It is therefore desired to develop an X-ray diagnosis apparatus, medical image processing apparatus, and image processing method which can display information of an object to be examined in the depth direction in order to accurately and easily perform a medical treatment or diagnosis.

### BRIEF SUMMARY OF THE INVENTION

It is an object of the present invention to implement support for operation in catheterization and a reduction in exposure.

According to a first aspect of the present invention, there is provided.a.medical image processing apparatus characterized by comprising:

an image storage unit which stores data of a three-dimensional image associated with an object receiving an operation using a lumen insertion device;

a lumen detection unit which detects a lumen line representing a run state of a lumen from the three-dimensional image;

a current position specifying unit which specifies a current position of the lumen insertion tube based on an insertion distance from a reference position associated with the lumen insertion device and the detected lumen line;

a cross-sectional image generating unit which creates data of a cross-sectional image associated with a cross-section passing through at least one of the current position on the lumen line, a position ahead of the current position, and a position behind the current position from data of the three-dimensional image; and

a display unit which displays the created data of the cross-sectional image.

According to a second aspect of the present invention, there is provided.an X-ray diagnosis apparatus characterized by comprising:

an X-ray tube;

an X-ray detector;

an image storage unit which stores data of a three-dimensional image associated with an object receiving an operation using a lumen insertion device;

a lumen detection unit which detects a lumen centerline associated with a specific lumen from the three-dimensional image;

a distance measuring unit which repeatedly measures an insertion distance of the lumen insertion device;

a current position specifying unit which repeatedly specifies a current position of the lumen insertion device based on the measured insertion distance of the lumen insertion device and the detected lumen centerline;

a cross-sectional image generating unit which repeatedly generates data of a cross-sectional image associated with a cross-section passing through at least one of the current position on the lumen line, a position ahead of the current position, and a position behind the current position from the data of the three-dimensional image; and

a display unit which displays the generated data of the cross-sectional image.

### BRIEF DESCRIPTION OF THE SEVERAL VIEWS OF THE DRAWING

FIG. 1 is a view showing an overview of the configuration of an X-ray diagnosis apparatus according to embodiment 1-1;

FIG. 2 is a block diagram of the X-ray diagnosis apparatus according to embodiment 1-1;

FIG. 3 is a view for explaining how an image processing unit extracts a cross-cut image at the current position of the distal end of a catheter;

FIG. 4 is a view for explaining how a mark adding unit adds a mark to the current position of the distal end of the catheter on a CPR image;

FIG. 5 is a flowchart for medical image display for supporting a medical treatment by an X-ray diagnosis apparatus according to embodiment 2-1;

FIG. 6 is a block diagram showing the arrangement of the X-ray diagnosis apparatus according to embodiment 2-1;

FIG. 7 is a flowchart for explaining the operation of the X-ray diagnosis apparatus according to embodiment 2-1;

FIG. 8 is a view for explaining a display example of CT image data in embodiment 2-1;

FIG. 9 is a view showing a display example of a blood vessel extraction image from CT image data in embodiment 2-1;

FIG. 10 is a view for explaining a display example of a two-dimensional angiogram in embodiment 2-1;

FIG. 11A is a view for explaining a display example in embodiment 2-1;

FIG. 11B is a view for explaining a display example in embodiment 2-1;

FIG. 12 is a view for explaining a display example of a cross-sectional blood vessel image in embodiment 2-1;

FIG. 13 is a flowchart for explaining the operation of the X-ray diagnosis apparatus according to embodiment 2-1;

FIG. 14 is a flowchart for explaining the operation of an X-ray diagnosis apparatus according to embodiment 2-3;

FIG. 15 is a view showing a display example in embodiment 2-3;

FIG. 16 is a flowchart showing a reference position calibration sequence in a modification;

FIG. 17A is a supplementary view for S14 in FIG. 16; and

FIG. 17B is a supplementary view for S15 in FIG. 16.

### DETAILED DESCRIPTION OF THE INVENTION

The present invention will be described below with reference to embodiments.

The present invention is relevant to intravascular devices. A typical intravascular device is a catheter. However, an intravascular device of the present invention can be any one of forceps, catheter, guide wire, stent, and actuator system. The following description is based on the assumption that an intravascular device is a catheter.

The present invention provides images associated with a specific position of a catheter. This specific position is typically the distal end of a catheter. However, the specific position of a catheter of the present invention can be either the distal end, an intermediate position located a predetermined distance from the distal end, or a stent marker position. The following description is based on the assumption that the specific position of the catheter of the present invention is the distal end position of the catheter.

### Embodiment 1-1

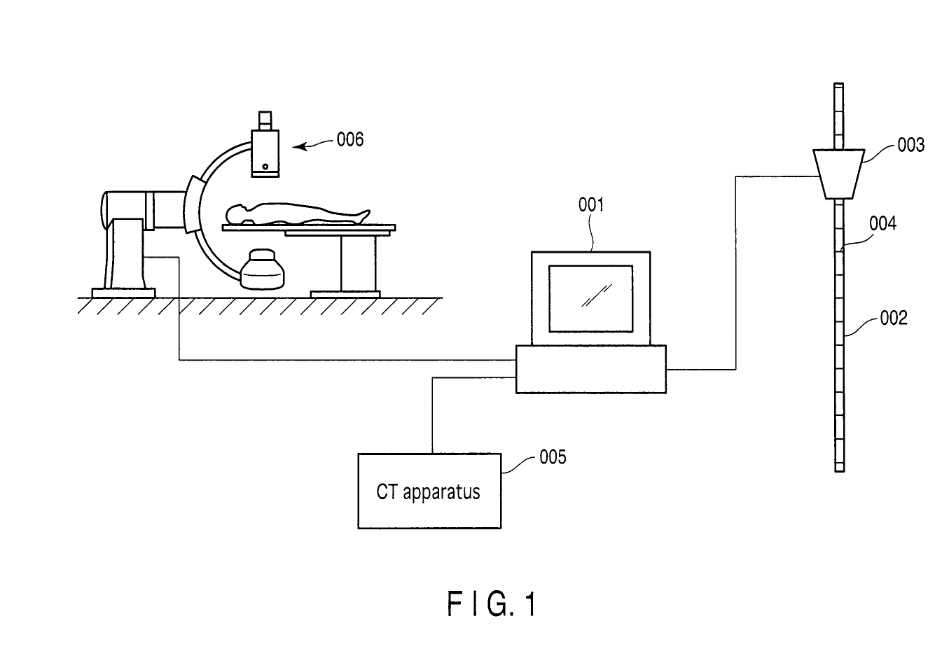

The overall configuration of an X-ray diagnosis apparatus according to this embodiment will be described with reference to FIG. 1. As shown in FIG. 1, an image diagnosis system according to this embodiment includes a medical image diagnosis apparatus such as a CT apparatus 005, a workstation 001 connected to the CT apparatus 005 via a network, an X-ray image diagnosis apparatus 006 connected to the workstation 001 via the network, a hub 003 incorporating a sensor 111 connected to the workstation 001, and a catheter 002. This embodiment uses the CT apparatus 005 as an apparatus to form a medical image for supporting a medical treatment. However, it suffices to use any other apparatus to form medical images which can be used for supporting a medical treatment. For example, an MRI apparatus or a 3D (three-dimensional) angiography apparatus can be used. This embodiment makes the workstation 001 display images formed by the X-ray image diagnosis apparatus 006. However, it suffices to display such images on another monitor. The X-ray image diagnosis apparatus 006 includes an “X-ray imaging means” and an “image creating means”. In this embodiment, a display unit 107 of the workstation 001 corresponds to an “X-ray image display means”.

The X-ray image diagnosis apparatus 006 includes a bed on which an object to be examined is placed, a gantry, an X-ray source to emit X-rays to the object, an X-ray detector to detect X-rays transmitted through the object, and a C-arm to hold the X-ray source and the X-ray detector so as to make them face each other. This C-arm is attached to the gantry so as to allow the X-ray source and the X-ray detector to be rotatable about two axes, as rotation centers, which pass through the isocenter and are almost perpendicular to each other.

Scale marks 004 are formed on the catheter 002 at equal intervals. For the sake of descriptive convenience, FIG. 1 shows the scale marks 004 at large intervals. However, these scale marks are in mm. In addition, since the smaller the intervals of the scale marks 004, the higher the accuracy of distance measurement, it is preferable to decrease the intervals of the scale marks 004 in accordance with the required accuracy of distance measurement. An operator such as a doctor (to be simply referred to as an “operator” hereinafter) inserts the catheter 002 into a lumen of an object to be examined, typically a blood vessel, such that it reaches an affected part such as a stenosis region. The operator inserts the catheter 002 under X-ray fluoroscopy. That is, the operator inserts the catheter 002 while referring to an X-ray image of a state in which the catheter 002 is inserted. The operator treats the affected part by using a balloon (not shown) attached to the distal end of the catheter 002 while referring to an X-ray fluoroscopic image generated by the X-ray image diagnosis apparatus 006 which is displayed on the workstation 001.

The hub 003 has a hole allowing the catheter 002 to pass through. The catheter 002 is placed to pass through the hole provided in the hub 003 and be slidable in a direction perpendicular to the circumferential direction of the hole. The operator brings the hub 003 into contact with the object to allow the catheter 002 to be movable only in a direction perpendicular to the circumferential direction of the hole while fixing the movement of the catheter 002 in the circumferential direction of the hole. This facilitates the insertion of the catheter 002 into a blood vessel. The hub 003 is provided with the sensor 111 for reading the scale marks 004 of the catheter 002 (to be described later).

The workstation 001 acquires a medical image from the CT apparatus 005 in advance before the insertion of the catheter 002. In this case, in this embodiment, the workstation 001 acquires a medical image from the CT apparatus 005 in advance to increase the processing speed of the workstation 001. However, the workstation 001 may acquire a necessary medical image from the CT apparatus 005 when necessary instead of acquiring it in advance. In addition, the embodiment includes the workstation 001, independently of the CT apparatus 005, as a medical image processing apparatus for creating and displaying images to be referred to at the time of a medical treatment using the catheter 002. However, a medical image diagnosis apparatus such as the CT apparatus 005 may directly incorporate the function of a medical image processing apparatus.

The CT apparatus 005 creates a medical image by irradiating the object with X-rays and performing processing for the transmitted X-rays. In this case, this embodiment creates volume rendering, 2D (two-dimensional) projection, CPR, SPR, fly-through, MIP, and cross-cut images based on the three-dimensional image data (volume data) acquired by the CT apparatus 005. At this time, the CT apparatus 005 obtains a blood vessel core line (a line corresponding to almost the center of a blood vessel) by, for example, extracting a blood vessel based on a threshold for signal values, performing thinning of the blood vessel, and connecting the centers of inscribed circles at the respective points of the result of thinning. This blood vessel core line is used as an example of a blood vessel line (lumen line) representing the run state of the blood vessel.

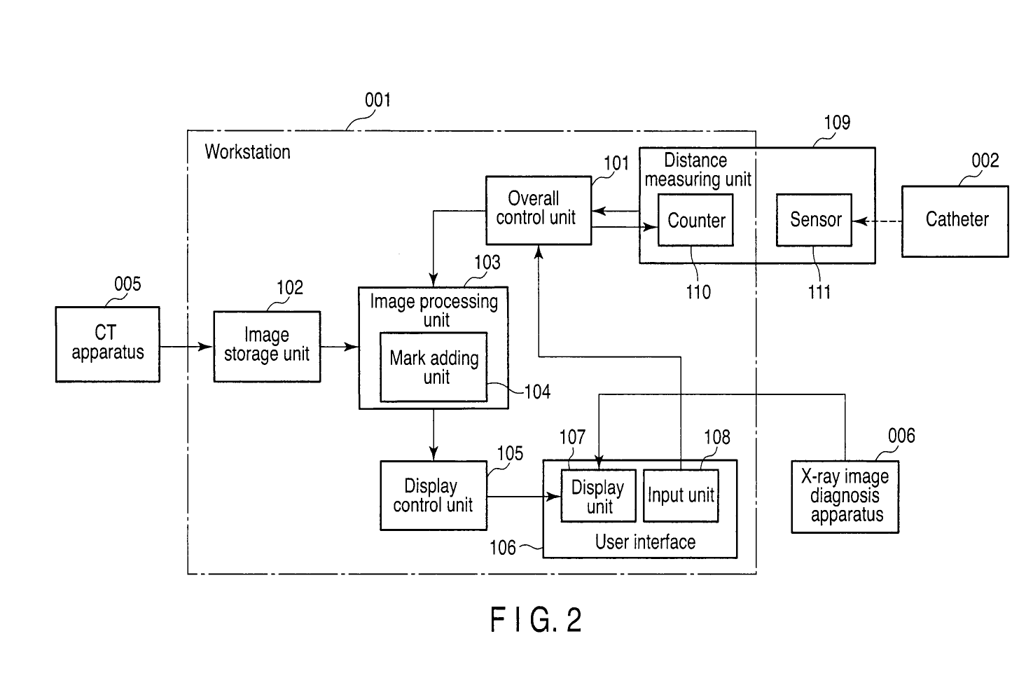

The details of the X-ray diagnosis apparatus will be described next with reference to FIG. 2. As shown in FIG. 2, the workstation 001 includes an overall control unit 101, an image storage unit 102, an image processing unit 103, a display control unit 105, a user interface 106 including the display unit 107 and an input unit 108, and a counter 110 which is part of a distance measuring unit 109.

The image storage unit 102 is a storage medium such as a hard disk or a memory. The image storage unit 102 stores the three-dimensional image data formed by the CT apparatus 005 and volume rendering, 2D projection, CPR, SPR, fly-through, MIP, and cross-cut images as medical images created based on the three-dimensional medical image data. This embodiment makes the image storage unit 102 store the above six types of images to allow the operator to refer to more images. However, the present invention may store at least one type of images. In addition, the present invention may use images other than the above six types.

The image storage unit 102 further stores the information of the blood vessel core line obtained by the CT apparatus 005. In this case, the information of a blood vessel core line is information representing the coordinate positions of points on a blood vessel core line in a coordinate space in which each image is expressed in correspondence with distances on the blood vessel core line. That is, it is possible to obtain the distance between two points on the blood vessel core line from the information of the blood vessel core line. In addition, the above fly-through and cross-cut images each are stored in correspondence with a point on the blood vessel core line. The image storage unit 102 corresponds to a “storage unit” in the present invention. The fly-through and cross-cut images each correspond to the “first medical image” in the present invention. The volume rendering, 2D projection, CPR, MIP, and SPR images each correspond to the “second medical image”.

The distance measuring unit 109 includes the counter 110 and the sensor 111. As described above, the counter 110 is placed in the workstation 001. The sensor 111 is placed in the hub 003 belonging to the catheter 002. The distance measuring unit 109 corresponds to a “distance measuring means”.

The sensor 111 optically senses the scale marks 004 marked on the catheter 002. In this case, the direction in which the catheter 002 is made to travel deep in a blood vessel is called a “traveling direction”, and the direction in which the catheter 002 is removed from the blood vessel is called a “backward direction”. Every time sensing the scale mark 004 as the catheter 002 travels in the traveling direction, the sensor 111 transmits a signal of “+1” to the counter 110. Every time sensing the scale mark 004 as the catheter 002 travels in the backward direction, the sensor 111 transmits a signal of “−1” to the counter 110. “+1” and “−1” of the counter 110 each correspond to the minimum unit of the scale marks 004. The sensor 111 reads the scale marks 004 with the accuracy of the minimum unit.

The distance measuring unit 109 receives a signal from the overall control unit 101 based on the designation of a reference position by the operator. This reference position indicates a point on a blood vessel, in which the catheter 002 is inserted, at which the distal end of the catheter 002 is located and which serves as a reference when the distance measuring unit 109 measures a distance. The operator designates a reference position when inserting the catheter 002 for the first time or having changed the target blood vessel to be described later. The distance measuring unit 109 measures the distance by which the distal end of the catheter 002 has moved from the reference position. Upon receiving an input of the designation of a reference position, the distance measuring unit 109 resets the counter 110. The counter 110 increments the counter by one upon receiving a signal of “+1” from the sensor 111. The counter 110 decrements the counter by one upon receiving a signal of “−1”.

The distance measuring unit 109 obtains the distance by which the distal end of the catheter 002 has moved from the reference position, based on the value of the counter 110. The distance measuring unit 109 outputs, to the overall control unit 101, the obtained distance by which the distal end of the catheter 002 has moved from the reference position.

The overall control unit 101 controls the operation of each functional unit. In practice, each control unit transmits and receives information via the overall control unit 101. For the sake of descriptive convenience, there is some description that functional units directly transmit/receive information to/from each other without via the overall control unit 101.

The overall control unit 101 receives an input of the designation of a reference position by the operator from the input unit 108. In this case, the operator inputs to designate a reference position by pressing a button for reference position designation when the catheter 002 is located at a characteristic position (e.g., the root of a coronary artery (coronary artery stem)) or the like while referring to the X-ray image currently created by the X-ray image diagnosis apparatus 006. The overall control unit 101 outputs a signal to the distance measuring unit 109 based on the designation of the reference position. Thereafter, the overall control unit 101 receives, from the distance measuring unit 109, an input of the distance by which the distal end of the catheter 002 has moved. The overall control unit 101 then outputs, to the image processing unit 103, the distance by which the distal end of the catheter 002 has moved.

The image processing unit 103 has a mark adding unit 104. The image processing unit 103 receives the designation of a medical image corresponding to the reference position input by the operator and stores the information of the medical image. As described above, since a characteristic position is designated as a reference position, the operator can easily specify the corresponding place. It is therefore easy for the operator to designate a medical image corresponding to the place. The designation of a medical image corresponding to a reference position in each type of medical image will be specifically described below. The image processing unit 103 corresponds to an “image processing means” in the present invention.

The operator designates fly-through and cross-cut images at a reference position as medical images corresponding to the reference position from the medical images stored in the image processing unit 103 and makes the image processing unit 103 store the identification information of each of the images by using the user interface 106. In this case, the fly-through and cross-cut images at the reference position are respectively a fly-through image at a viewpoint at which a blood vessel is seen deep from the reference position and a cross-cut image obtained when a blood vessel is cut along a plane perpendicular to the blood vessel at a reference position. At this time, the image processing unit 103 stores information indicating that the designated image is an image corresponding to a specific position on the blood vessel core line stored in the image storage unit 102.

In contrast, volume rendering, 2D projection, CPR, MIP, and SPR images each depict an overall blood vessel and are not a medical image corresponding to each point on the blood vessel. For this reason, in the case of volume rendering, 2D projection, CPR, MIP, and SPR images, it is not possible to designate an image at a reference position. The operator therefore makes the display unit 107 display volume rendering, 2D projection, CPR, MIP, and SPR images and adds marks to reference positions on blood vessel depicted in the respective images by using the user interface 106. The operator then makes the image processing unit 103 store the positions on the respective images including volume rendering, 2D projection, CPR, MIP, and SPR images to which the marks are added. At this time, the image processing unit 103 stores information indicating a specific position on a blood vessel core line to which a reference position corresponds by referring to the information of the blood vessel core line and the information of the position marked on the blood vessel as the reference position, which are stored in the image storage unit 102.

The operator further designates a blood vessel as a target into which the catheter 002 is to be inserted. More specifically, the operator designates, by using the user interface 106, a blood vessel by designating a blood vessel core line of a blood vessel as a target into which the catheter 002 is to be inserted from the blood vessel core lines stored in the image storage unit 102. The operator performs this blood vessel designation when he/she has inserted the catheter 002 for the first time and when he/she changes the blood vessel into which the catheter 002 is to be inserted during a medical treatment. The image processing unit 103 stores the information of the blood vessel designated as the target. The image processing unit 103 performs the following processing for the blood vessel selected as the target.

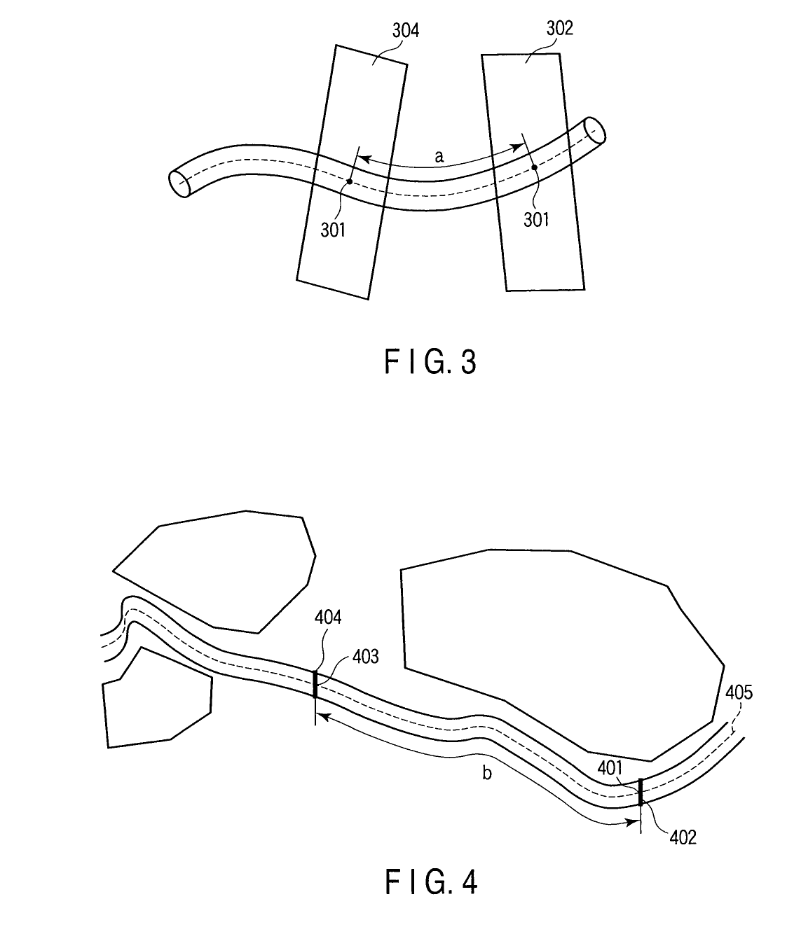

The image processing unit 103 extracts fly-through and cross-cut images corresponding to the current position of the distal end of the catheter 002 based on the moving distance of the distal end of the catheter 002 from the reference position input from the overall control unit 101. For this operation, first of all, the image processing unit 103 obtains a position on the blood vessel core line which corresponds to the reference position from an image designated as an image at the reference position. The image processing unit 103 then obtains a position on the blood vessel core line which corresponds to the current position of the distal end of the catheter 002 based on the obtained position on the blood vessel core line which corresponds to the reference position and the input moving distance. With this operation, the above extraction can be executed. The image processing unit 103 then extracts fly-through and cross-cut images at the current position of the distal end of the catheter 002 from the image storage unit 102 based on the obtained position on the blood vessel core line. The extraction of a cross-cut image at the current position of the distal end of the catheter 002 by the image processing unit 103 will be described with reference to FIG. 3. FIG. 3 is a view for explaining the extraction of a cross-cut image at the current position of the distal end of the catheter 002 by the image processing unit 103. The image processing unit 103 obtains a reference position 301 on a blood vessel core line 305 based on the information of a cross-cut image 302 at an input reference position. The image processing unit 103 receives a moving distance a of the distal end of the catheter 002 measured by the distance measuring unit 109. The image processing unit 103 obtains a point 303 moved on the blood vessel core line by the distance a from the reference position 301 based on the distance of the blood vessel core line 305 stored in the image storage unit 102. The image processing unit 103 then extracts a cross-cut image 304 at the point 303 stored in the image storage unit 102.

The mark adding unit 104 adds a mark to the current position of the distal end of the catheter 002 on the blood vessel in each of volume rendering, 2D projection, CPR, MIP, and SPR images based on the moving distance of the distal end of the catheter 002 from the reference position input from the overall control unit 101. More specifically, the mark adding unit 104 adds a mark to the position on the blood vessel core line which is moved, by the moving distance, from the position on the blood vessel core line which corresponds to the reference position stored in the image processing unit 103. The addition of a mark to the current position of the distal end of the catheter 002 in a CPR image by the mark adding unit 104 will be described with reference to FIG. 4. FIG. 4 is a view for explaining the addition of a mark to the current position of the distal end of the catheter 002 in a CPR image by the mark adding unit 104. The mark adding unit 104 receives a reference position 401 obtained from a mark 402 on a blood vessel core line 405 in a CPR image. The mark adding unit also receives a moving distance b of the distal end of the catheter 002 measured by the distance measuring unit 109. The mark adding unit 104 then obtains a point 403 moved on the blood vessel core line from the reference position 401 by the distance b based on the distance of the blood vessel core line 405 stored in the image storage unit 102. The mark adding unit 104 adds a mark 404 corresponding to the position of the point 403 in the CPR image stored in the image storage unit 102.

As described above, this apparatus extracts fly-through and cross-cut images corresponding to the current position of the distal end of the catheter 002 based on the moving distance of the distal end of the catheter 002 from the reference position, and creates volume rendering, 2D projection, CPR, MIP, and SPR images each having a mark added to the current position of the distal end of the catheter 002. This operation corresponds to the processing of “associating the position of the distal end with a medical image including the position of the distal end” in the present invention.

The image processing unit 103 outputs, to the display control unit 105, the acquired fly-through and cross-cut images and the volume rendering, 2D projection, CPR, MIP, and SPR images to which the marks are added.

The display control unit 105 causes the display unit 107 to display fly-through, cross-cut, volume rendering, 2D projection, CPR, MIP, and SPR images corresponding to the current position of the distal end of the catheter 002 based on a format stored in advance. The display control unit 105 corresponds to a “display control means” in the present invention.

In this case, this embodiment displays all types of images including fly-through, cross-cut, volume rendering, 2D projection, CPR, MIP, and SPR images, which are stored medical images, as medical images corresponding to the current position of the distal end of the catheter 002, in order to increase the amount of information used for medical treatment support by displaying more images. However, it suffices to display one or any of these images. For example, this apparatus can be configured to make the operator select a type of image required in advance from the stored types of medical images by using the user interface 106, cause the image processing unit 103 to acquire or create only an image of the selected type and output it to the display control unit 105, and make the display control unit 105 cause the display unit 107 to display the selected type of medical image.

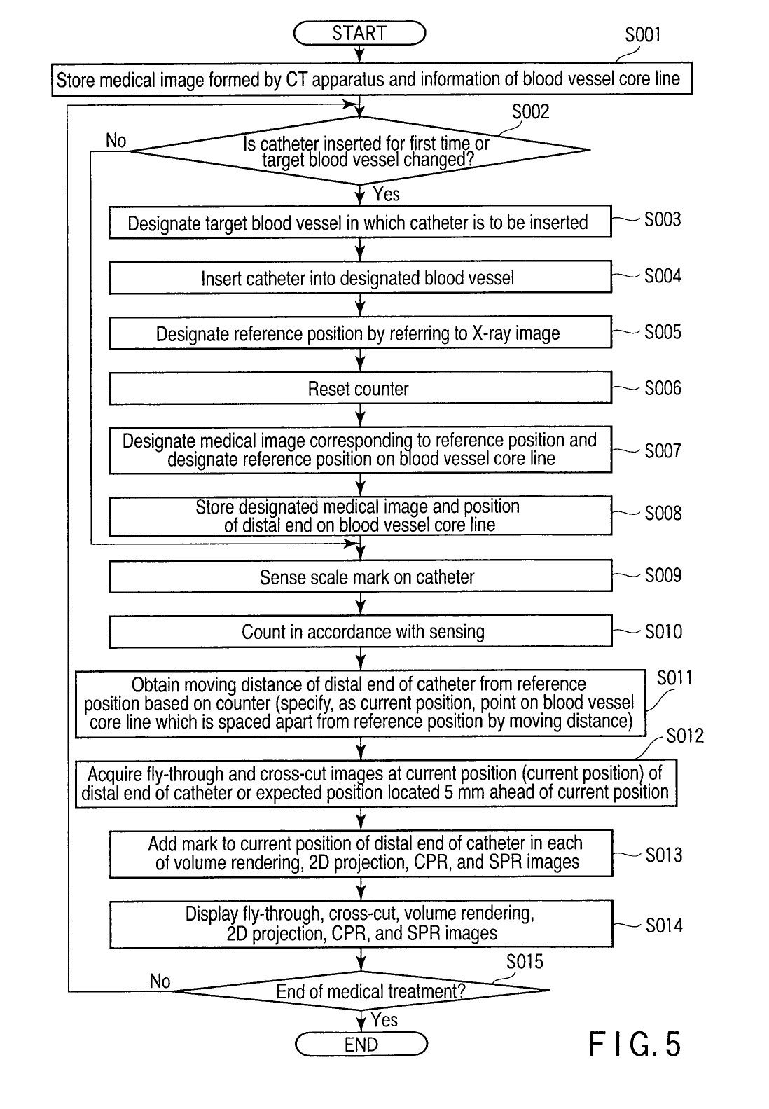

A display sequence of medical images for supporting a medical treatment by the medical image processing apparatus according to this embodiment will be described next with reference to FIG. 5. FIG. 5 is a flowchart for medical image display for supporting a medical treatment by the medical image processing apparatus according to this embodiment.

Step S001: The image storage unit 102 receives the three-dimensional image data and blood vessel core line information formed by the CT apparatus 005 and stores the medical image and the blood vessel core line information. In this case, the direction of the C-arm is associated with the direction of this three-dimensional image data. Based on this information of association, when the C-arm is rotationally moved afterward, the directions of volume rendering, 2D projection, CPR, MIP, and SPR images created from the three-dimensional image data by image processing are changed in conjunction with the rotational movement of the C-arm.

Step S002: If the catheter 002 is to be inserted into a blood vessel for the first time or the blood vessel into which the catheter 002 is to be inserted is changed, the process advances to step S003. If the catheter 002 has already been inserted in the blood vessel and the blood vessel in which the catheter 002 is inserted is not changed, the process advances to step S009.

Step S003: The operator designates, by using the user interface 106, a target blood vessel into which the catheter 002 is to be inserted.

Step S004: The operator inserts the catheter 002 into the blood vessel designated in step S003.

Step 005: The operator inputs the designation of a reference position at a characteristic position by using the input unit 108 while referring to an X-ray image of the object in the current state in which the catheter 002 is inserted.

Step S006: The counter 110 resets the counter upon receiving an input of a signal designating the reference position from the overall control unit 101.

Step S007: The operator inputs the designation of fly-through and cross-cut images corresponding to the reference position to the image processing unit 103 by using the user interface 106. The operator further inputs the designation of reference positions on blood vessel core lines of the respective images to the image processing unit 103 by adding marks to the reference positions on volume rendering, 2D projection, CPR, MIP, and SPR images.

Step S008: Based on the input designation, the image processing unit 103 stores the information of the corresponding fly-through and cross-cut images and the information of the reference positions on the blood vessel core lines on the volume rendering, 2D projection, CPR, and SPR images.

Step S009: The sensor 111 senses the scale mark 004 of the catheter 002. Upon counting the scale mark 004 in the traveling direction, the sensor outputs “+1” to the counter 110. Upon counting the scale mark 004 in the backward direction, the sensor outputs “−1” to the counter 110.

Step S010: The counter 110 increments its count by one upon receiving an input of “+1” from the sensor 111, and decrements its count by one upon receiving an input of “−1”.

Step S011: The distance measuring unit 109 obtains the distance by which the distal end of the catheter 002 has moved from the reference position based on the count of the counter 110.

Step S012: The image processing unit 103 receives the moving distance of the distal end of the catheter 002 from the reference position, which is measured by the distance measuring unit 109, and creates fly-through and cross-cut images whose positions have moved to the position of the point at which the distal end of the catheter 002 is currently located, based on the information of the three-dimensional image data stored in the image storage unit 102.

Step S013: Upon receiving the moving distance of the distal end of the catheter 002 from the reference position, which is measured by the distance measuring unit 109, based on the reference positions on blood vessel core lines on the stored volume rendering, 2D projection, CPR, and SPR images, the mark adding unit 104 adds marks to places where the distal end of the catheter 002 is currently located in the volume rendering, 2D projection, CPR, MIP, and SPR images.

Step S014: The display control unit 105 receives, from the image processing unit 103, the fly-through and cross-cut images at the point at which the distal end of the catheter 002 is currently located and the volume rendering, 2D projection, CPR, MIP, and SPR images having the marks added to the places where the distal end of the catheter 002 is currently located, and causes the display unit 107 to display the images.

Step S015: When the medical treatment is complete, the medical image processing apparatus finishes the operation of display of medical images for supporting the medical treatment. If the medical treatment is not complete, the process advances to step S002.

As described above, the medical image processing apparatus according to this embodiment obtains the distance by which the distal end has moved from a reference position, and can automatically display fly-through and cross-cut images at the current position of the distal end of the catheter 002 and volume rendering, 2D projection, CPR, MIP, and SPR images to which marks indicating the current position of the distal end of the catheter 002 are added, based on the obtained distance. This allows the operator to easily refer to images for medial treatment support and eliminates the necessity to designate a medical image at the current position of the distal end of the catheter 002 or empirically determine at which position the distal end of the catheter 002 is located. The medical image processing apparatus according to this embodiment can therefore contribute to improvements in the efficiency and accuracy of medical treatments.

This embodiment uses a blood vessel core line to associate a distance with an image or a mark. However, it suffices to use another criterion as long as it can associate with a distance on a blood vessel. For example, it suffices to use a structural line obtained by simply thinning a blood vessel.

### Embodiment 1-2

A medical image processing apparatus according to embodiment 1-2 of the present invention will be described below. The medical image processing apparatus according to this embodiment is configured to be different from the first embodiment in that upon receiving the designation of a reference position using one type of medical image by an operator, the apparatus can determine a reference position in another medical image. The following description is mainly directed to the designation of a reference position and the selection of a medical image associated with the position of the distal end after movement. The arrangement of the functional units of the medical image processing apparatus according to this embodiment is the same as that in the block diagram of FIG. 2.

This embodiment selects and creates one type of medical image of volume rendering, 2D projection, CPR, SPR, fly-through, MIP, and cross-cut images based on the three-dimensional image data (volume data) stored in an image storage unit 102. The operator then designates a medical image corresponding to a reference position by using the selected type of medical image. That is, when the operator selects a fly-through or cross-cut image, he/she designates a fly-through or cross-cut image at the reference position. When the operator selects a volume rendering, 2D projection, CPR, MIP, or SPR image, he/she adds a mark to the reference position on the selected medical image.

An image processing unit 103 obtains a reference position on a blood vessel core line based on the associated medical image. More specifically, when the operator uses a fly-through or cross-cut image to designate a medical image corresponding to a reference position, the image processing unit 103 obtains information indicating that the fly-through or cross-cut image is a medical image at a specific position on the blood vessel core line, and stores the position on the blood vessel core line. When the operator uses a volume rendering, 2D projection, CPR, MIP, or SPR image to designate a medical image corresponding to a reference position, the image processing unit 103 obtains information indicating to which position on the blood vessel core line the position of the mark corresponds, and stores the position.

The image processing unit 103 extracts a medical image associated with the current position of the distal end of the catheter 002 based on the position of the reference position on the blood vessel core line and the moving distance of the position of the distal end of a catheter 002 measured by a distance measuring unit 109, or creates a medical image based on three-dimensional image data (volume data). The image processing unit 103 extracts or creates this medical image for not only the type of medical image used for the designation of a medical image corresponding to a reference position but also other types of medical images. The image processing unit 103 outputs the medical image associated with the position of the distal end of the catheter 002 to a display control unit 105.

The display control unit 105 causes a display unit 107 to display a medical image associated with the position of the distal end of the catheter 002 which is input from the image processing unit 103.

As described above, by designating medical images corresponding to a reference position in one type of medical image, the medical image processing apparatus according to this embodiment can display other types of medical images associated with the current position of the distal end of the catheter 002. This can reduce the load on the operator and perform a more efficient medical treatment.

### Embodiment 2-1

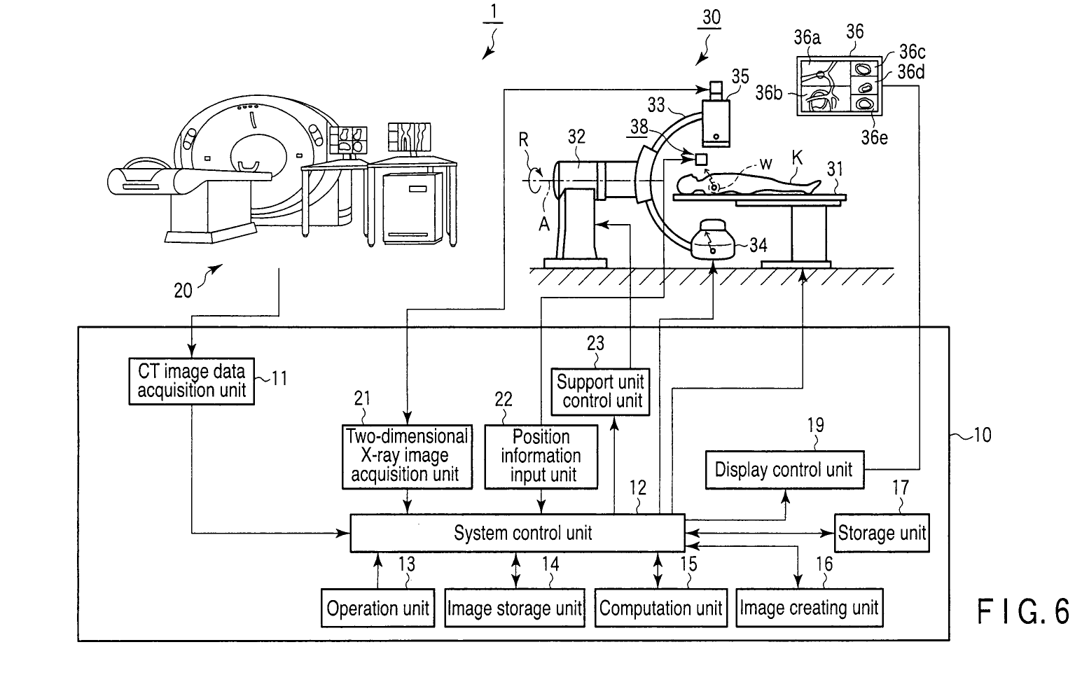

An X-ray diagnosis apparatus, medical image processing apparatus, and image processing method according to embodiment 2-1 of the present invention will be described below with reference to FIGS. 6 to 13. FIG. 6 is a block diagram showing the arrangement of an X-ray diagnosis apparatus 1. The apparatus 1 includes a medical image processing apparatus 10, a CT apparatus 20, and an X-ray diagnosis apparatus 30. The three-dimensional image data recorded by the CT apparatus are sent to the medical image processing apparatus 10 via a network or the like.

The medical image processing apparatus 10 includes a CT image data acquisition unit 11 (image acquisition means), an system control unit 12, an operation unit 13, an image storage unit 14, a computation unit 15, an image creating unit 16 (creating means/extraction means), a storage unit 17, a display control unit 19, a two-dimensional X-ray image acquisition unit 21 (image acquisition means), and a position information input unit 22 (position acquisition means).

The CT image data acquisition unit 11 is configured to acquire desired CT three-dimensional image data from the CT apparatus 20. The apparatus control unit 12 controls the overall operation of the medical image processing apparatus 10. The operation unit 13 (input means) is configured to perform, for example, operation to click a specific portion on a screen or selection of an image, and includes a mouse and a control panel.

The image storage unit 14 is a storage means for storing the images acquired by the CT image data acquisition unit 11 (image acquisition means) and the two-dimensional X-ray image acquisition unit 21 (image acquisition means) and the like. The image creating unit 16 creates an image to be displayed on a monitor 36 (to be described later), together with the image storage unit 14.

The display control unit 19 displays, on the monitor 36, a cross-sectional image of a three-dimensional image created by the image storage unit 14 and the image creating unit 16. A support unit control unit 23 controls the position and angle of a C-arm 33 of the X-ray diagnosis apparatus 30 (to be described later). The two-dimensional X-ray image acquisition unit 21 is a means for acquiring two-dimensional image data from an X-ray detector 35 (to be described later). The position information input unit 22 is configured to acquire position information from a position detection device 38 in order to create a cross-sectional image (to be described later).

The X-ray diagnosis apparatus 30 includes a bed 31 on which an object K is placed, a gantry 32, the C-arm 33 which is supported on the gantry 32 and is pivotal about the P-axis in FIG. 6 in the direction indicated by an arrow R in FIG. 6, an X-ray source 34 provided on one end portion of the C-arm 33, the X-ray detector 35 provided on the other end portion of the C-arm 33, the display unit 36 (display means) having a plurality of monitors which display a plurality of images including created images, and the position detection device 38 (detection means) for detecting the position of a catheter W inserted into the body of an object K.

The display unit 36 displays an output three-dimensional image or the like on the screen via the display control unit 19, and includes, for example, five monitors of the image monitors 36, which display images, including a monitor 36a (first display means) which displays two-dimensional X-ray images, a CT monitor 36b which displays CT image data, and cross-sectional image monitors 36c to 36e which display cross-sectional images of blood vessels.

The bed 31 is movable in the vertical and horizontal directions. This allows the object K to be properly placed between the X-ray source 34 and the X-ray detector 35.

The C-arm 33 is configured to hold the X-ray source 34 and the X-ray detector 35 so as to make them face each other. Although not shown, the X-ray source 34 includes an X-ray tube which irradiates the object K with X-rays and a collimator which collimates the X-rays emitted from the X-ray tube. As the X-ray detector 35, for example, an I.I. (Image Intensifier) or an X-ray flat panel detector as a detection device other than an I.I can be used.

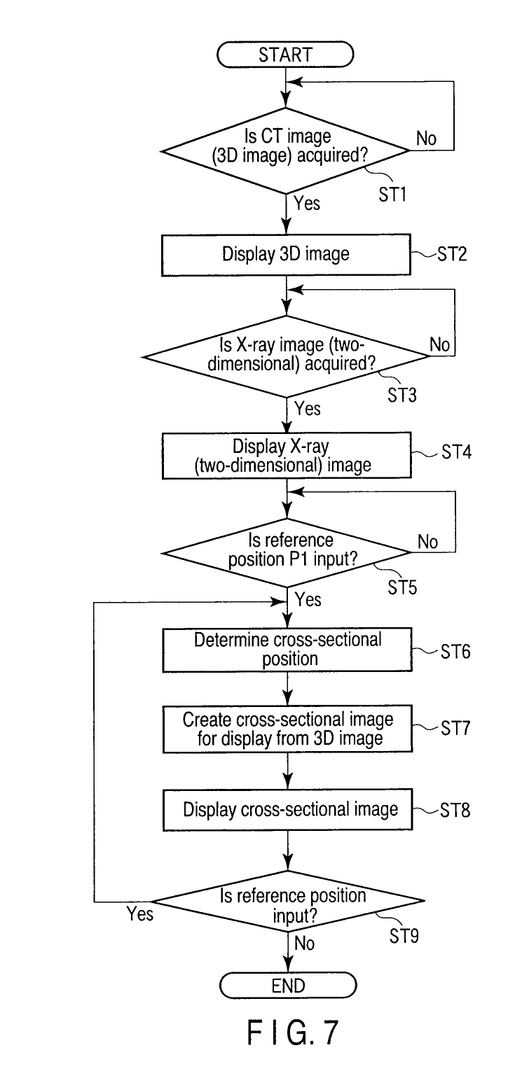

A processing sequence in the image display apparatus according to the first embodiment of the present invention in the case of, for example, catheterization will be described next with reference to the flowchart of FIG. 7.

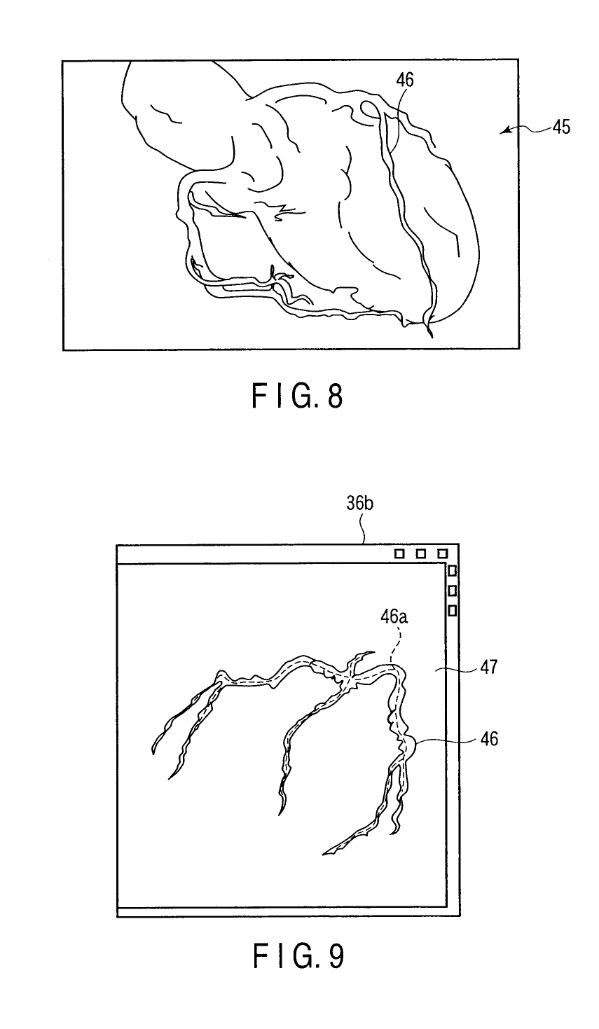

First of all, in step (ST) 1, the CT image data acquisition unit 11 acquires three-dimensional CT image data (three-dimensional image) 45 like that shown in FIG. 8 from the CT apparatus 20.

The three-dimensional CT image data 45 is volume data (three-dimensional image data) created by the CT (Computed Tomography) apparatus 20 which acquires X-ray two-dimensional images covering 360° around the body, and reconstructs a two-dimensional tomographic image by reconstruction computation. In this case, the direction of the C-arm 33 is associated with the direction of this three-dimensional image data. Based on this information of association, when the C-arm 33 is rotationally moved afterward, the directions of blood vessel extraction, volume rendering, 2D projection, CPR, MIP, and SPR images created from the three-dimensional image data by image processing are changed in conjunction with the rotational movement of the C-arm 33.

The apparatus then creates a blood vessel extraction image 47 for display from the volume data 45, and displays it on the CT monitor 36b (first display means) (ST2). More specifically, for example, first of all, the operator selects a specific blood vessel 46 by operation such as clicking with the operation unit 13 while the volume data 45 is displayed on the CT monitor 36b. With this operation, the apparatus control unit 12 creates the blood vessel extraction image 47 by extracting only the target blood vessel 46 from the volume data 45. FIG. 9 shows a display example of the blood vessel extraction image 47. The blood vessel extraction image 47 is displayed on, for example, the CT monitor 36b. Note that it suffices to use a volume rendering, 2D projection, CPR, SPR, fly-through, MIP, or cross-cut image instead of the blood vessel extraction image 47.

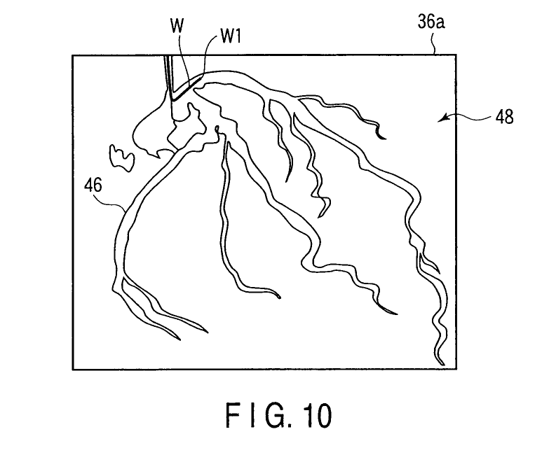

The two-dimensional X-ray image acquisition unit 21 acquires a two-dimensional X-ray image 48 of the object in the X-ray diagnosis apparatus 30 (ST3). The two-dimensional X-ray image 48 is displayed on the image monitor 36a of the display unit 36 (ST4). FIG. 10 shows a display example of the two-dimensional X-ray image 48. When the catheter W has already been inserted and located within a display image range, an image of the catheter W is also displayed. The operator can therefore check at which position the catheter W is located, by visually checking this two-dimensional X-ray image.

As shown in FIG. 7, when, for example, the operator clicks a given point on the displayed two-dimensional X-ray image with the operation unit 13, the point is designated as a reference position P1 (ST5). Note that the operator performs this clicking operation by using the mouse, keyboard, touch panel, or the like in the operation unit 13.

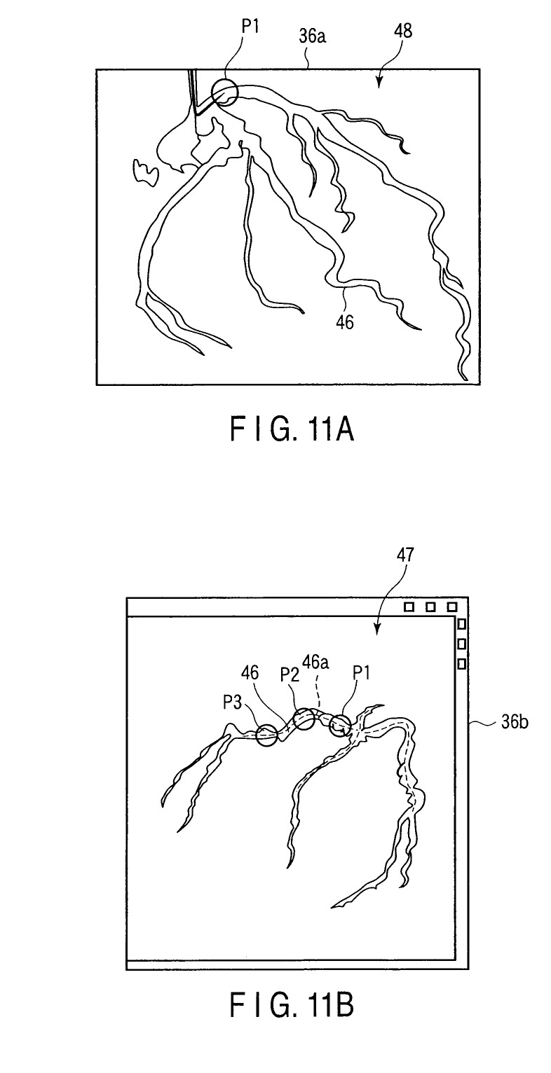

For example, as shown in FIG. 8, the operator designates the reference position P1 based on a position at which he/she wants to check a cross-sectional image for operation. The reference position P1 is typically a distal end position W1 of the catheter W. When the operator clicks the distal end W1 of the catheter W on the two-dimensional X-ray image, the coordinates of the reference position P1 on the two-dimensional X-ray image 48 are specified based on the input result. As shown in FIGS. 11A and 11B, a character P1 indicating the clicked portion on the screen is displayed on the screen. Based on this position information, the reference position P1 is also displayed on a portion on the blood vessel extraction image 47 which corresponds to P1. This allows the operator to know the correspondence with the reference position P1 on the blood vessel extraction image 47. Note that since the coordinates on the blood vessel extraction image 47 are associated with those on the two-dimensional X-ray image 48, the operator may input the reference position P1 by clicking a position at which the distal end W1 of the catheter W seems to be located on the blood vessel extraction image 47, while seeing a displayed two-dimensional X-ray image.

The apparatus then calculates and determines a target cross-sectional position at which a cross-sectional blood vessel image 49 is to be displayed later (ST6). In this case, the position detection device 38 calculates the reference position P1 and portions, as target cross-sectional positions P2 and P3 for the display of cross-sectional images, which are respectively located predetermined distances, e.g., 1 cm and 2 cm, ahead of the reference position P1 in the catheter insertion direction along a blood vessel core line 46a (a lumen line representing the run state of the blood vessel). The cross-sectional positions P2 and P3 are also displayed as shown in FIGS. 11A and 11B. Note that a cross-sectional image at a position located behind the reference position P1 can be displayed as well as at positions (forward positions) located ahead of the reference position P1.

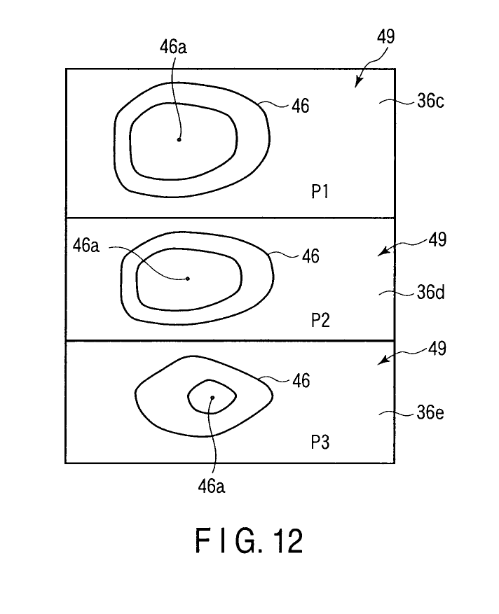

The apparatus then creates the cross-sectional images 49 of the blood vessel like those shown in FIG. 12 at the respective portions of the blood vessel 46 which correspond to the display target positions P1, P2, and P3 (ST7).

Note that as the volume data 45, volume data from which the coordinates of the blood vessel center have already been extracted is used. In an actual clinical case, since the operator traces the blood vessel core line 46a after CT imaging, the data of the blood vessel core line 46a can be used without any change.

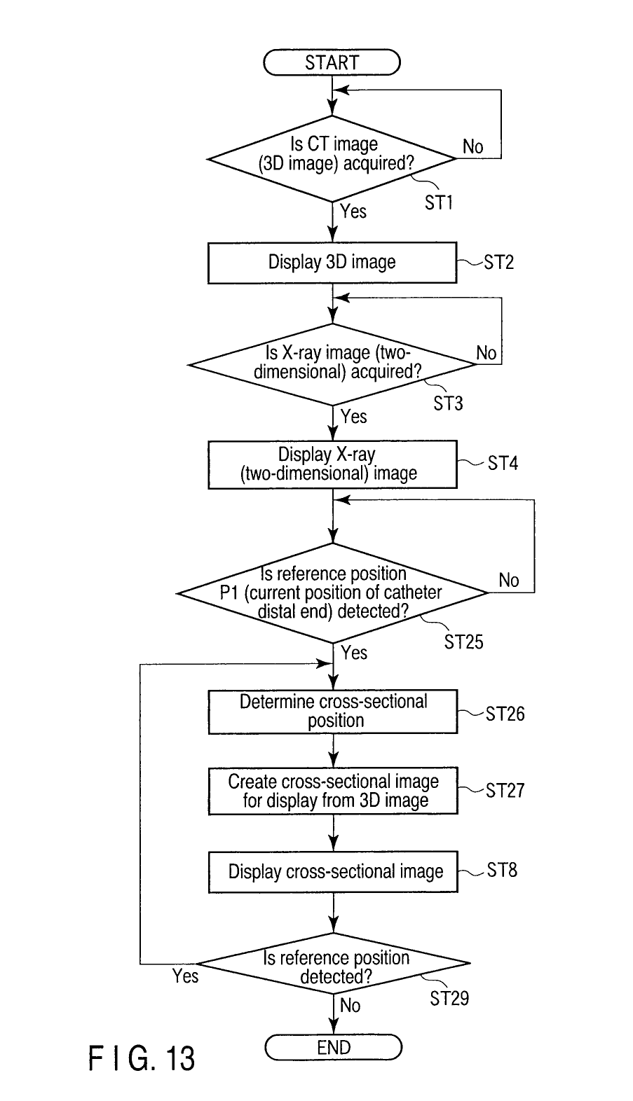

The three created cross-sectional blood vessel images 49 are respectively displayed on the monitors 36c to 36e as the second display means (ST8). For example, as shown in FIG. 13, the three cross-sectional blood vessel images 49 are sequentially displayed side by side. The cross-sectional blood vessel image 49 at the reference position P1, the cross-sectional blood vessel image 49 at the region P2 located 1 cm ahead of the reference position P1, and the cross-sectional blood vessel image 49 at the region P3 located 2 cm ahead of the reference position P1 in the same direction are sequentially displayed in the order named from above.

The operator can designate/input another region in the process of operation as an option (ST9). If there is an input, the process returns to ST5 described above. That is, when the operator inputs a reference position, the apparatus updates the display unit to display the input position and the cross-sectional blood vessel image 49 at the cross-sectional position corresponding to the reference position.

As described above, according to the first embodiment, the blood vessel extraction image 47, two-dimensional X-ray image 48, and cross-sectional blood vessel image 49 are displayed side by side, and the cross-sectional blood vessel image 49 of a region suitable for a medical treatment or diagnosis is displayed when the operator designates a position at which he/she wants to see a cross-sectional blood vessel image. This facilitates manipulation. The operator can therefore insert a catheter or a guide wire into a blood vessel while checking information of an object in the depth direction which cannot be known from only a two-dimensional X-ray image, e.g., the bends and cross-sectional area of the blood vessel. This technique is therefore effective for a medical treatment for a stenosis region, an aneurysm, or the like of the blood vessel 46. In addition, the technique is convenient because the operator can see a cross-section at every position suitable for a situation during an operation.

In addition, since the reference positions P1 of these images and other cross-sectional positions P2 and P3 (located ahead of or behind the reference position P1) are also displayed, the operator can easily gasp the relationship between the displayed images. This allows the operator to know intravascular states at an operation region and a region ahead of it from cross-sectional images.

An operator sometimes elaborates on a medical treatment plan by using the cross-sectional blood vessel images 49. For example, in a medical treatment to scrape off plaque in a blood vessel, it is necessary to elaborate on a medical treatment plan, e.g., determining on which side of the blood vessel and how much the operator should scrap off, by observing the direction in which plaque adheres and the amount of plaque. When using only the two-dimensional X-ray blood vessel image 48 obtained in real time by the X-ray diagnosis apparatus 1 in the catheter room, the operator must perform a medical treatment/diagnosis on the two-dimensional blood vessel image in the X-ray apparatus, which is displayed in front of his/her eyes, by referring to a cross-sectional blood vessel image before the medical treatment upon converting the three-dimensional geometric relationship between the cross-sectional image 49 before the medical treatment and the currently seen two-dimensional X-ray image 48 in his/her head. In contrast, according to this embodiment, it is possible to display the cross-sectional image 49 in real time even during an operation.

### Embodiment 2-2

An X-ray diagnosis apparatus, medical image processing apparatus, and image processing method according to embodiment 2-2 of the present invention will be described next with reference to FIG. 13. Note that the data processing apparatus, X-ray diagnosis apparatus, and data processing method according to this embodiment are the same as the data processing apparatus, X-ray diagnosis apparatus, and data processing method according to the first embodiment except for steps ST25 to ST29, and hence a repetitive description will be omitted.

In the first embodiment described above, the operator designates the reference position P1 by clicking on a two-dimensional X-ray image. In contrast, in embodiment 2-2, a position detection device 38 or the like detects the position information of a catheter W as a reference position P1.

In this embodiment, as shown in FIG. 13, after the processing in ST1 to ST4 is performed as in the first embodiment, a position information input unit 22 acquires the position information of the catheter W from the position detection device 38 (ST25). Based on this detection result, a region where the distal end of the catheter W is located is specified as the reference position P1, and the same processing as that in ST6 to ST8 in the first embodiment is performed (ST26, ST27, ST28). Furthermore, this embodiment detects the reference position P1 again (ST29) and repeats the above operation at predetermined time intervals or every time the catheter W moves by a predetermined distance.

As the position detection device 38 includes, for example, a device can be used which includes a light-emitting unit and a light-receiving unit and is configured to optically detect the moving distance of a catheter and calculate the distal end position of the catheter based on a blood vessel shape.

Alternatively, it suffices to specify a reference position by detecting a catheter position from a distal end position W1 of the catheter W displayed on a two-dimensional X-ray image 48.

The X-ray diagnosis apparatus, medical image processing apparatus, and image processing method according to this embodiment can obtain the same effects as those of the X-ray diagnosis apparatus, medical image processing apparatus, and image processing method according to the first embodiment described above. In this embodiment, since an operation is performed upon detection of the position of a catheter, it is possible to reduce the operation of the operator and allow him/her to perform the operation more quickly and accurately.

### Embodiment 2-3

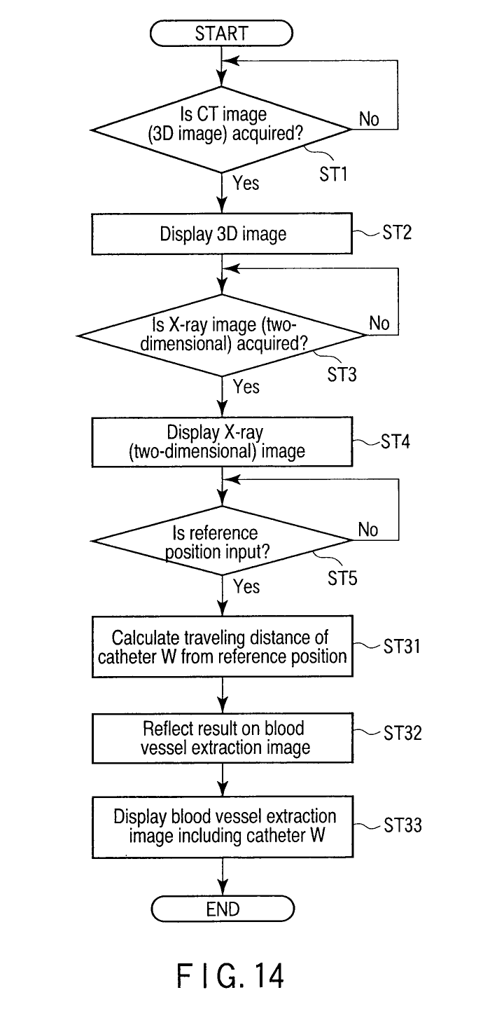

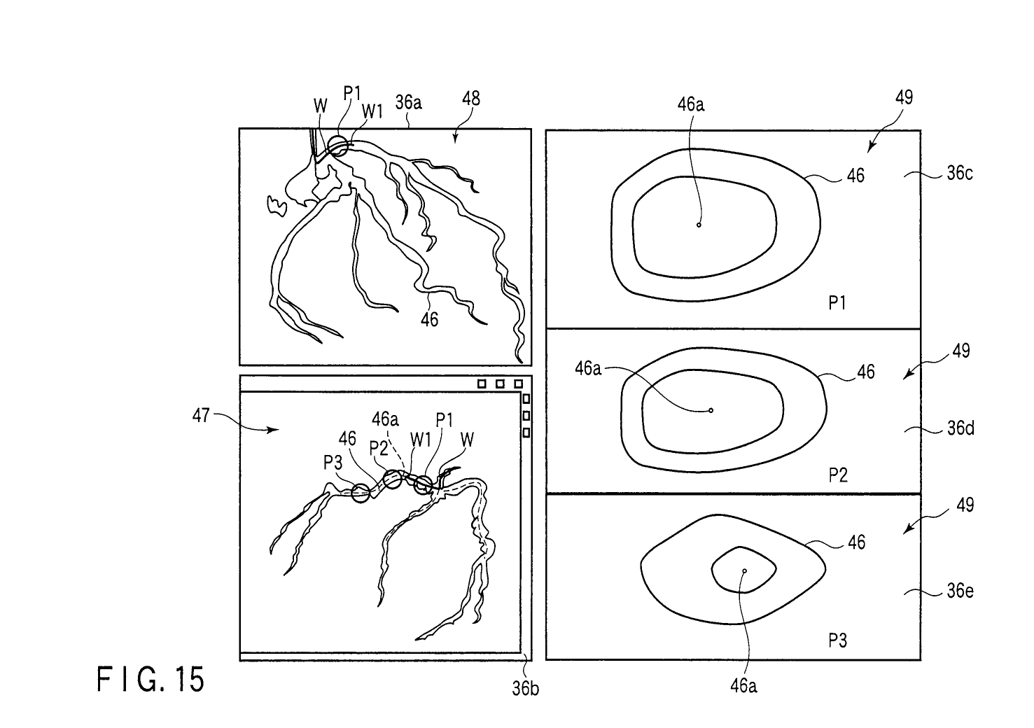

An X-ray diagnosis apparatus, medical image processing apparatus, and image processing method according to embodiment 2-3 of the present invention will be described next with reference to FIGS. 14 and 15. Note that the data processing apparatus, X-ray diagnosis apparatus, and data processing method according to this embodiment are the same as the data processing apparatus, X-ray diagnosis apparatus, and data processing method according to the second embodiment except for steps ST31 and ST32, and hence a repetitive description will be omitted.

In this embodiment, as indicated by ST31 to ST33 in the flowchart of FIG. 14, the distance by which a catheter W moves from the reference position P1 is repeatedly displayed on a blood vessel extraction image 47 at predetermined time intervals or every time the catheter W moves by a predetermined distance on the blood vessel extraction image 47 with respect to a reference position P1 designated on the two-dimensional image acquired by the X-ray diagnosis apparatus.

In this case, first of all, as in the first embodiment, the processing up to ST5 is performed. When the reference position P1 is input, the traveling distance of the catheter W from the input reference position P1 is calculated in ST31.

In ST32, the result is reflected in the blood vessel extraction image 47 (ST32) and, the resultant image is displayed (ST33). For example, at predetermined time intervals or every time the catheter W moves by a predetermined distance, the position of the catheter W is updated on the blood vessel extraction image 47 as the catheter W travels.

That is, in this embodiment, in addition to updating of the display of the cross-sectional blood vessel image 49 as shown in embodiments 1 and 2, the display position of the catheter W such as a catheter or guide wire is updated and displayed in accordance with the traveling distance of the catheter W, as shown in FIG. 15.

In addition to the same effects as those of the first and second embodiments, this embodiment can facilitate a medical treatment or diagnosis and improve their accuracy because the catheter W is displayed on the blood vessel extraction image 47.

### (Modification 1)

The present invention can be applied to, for example, MRI and PET data as long as they are 3D data in addition to CT image data. The types of data to which the present invention can be applied include, for example, coronary tree data and 3D angio data.

Volume data can be configured to allow clicking on two specific points on a cross-sectional image as long as it is data from which no blood vessel core line has been extracted.

The first, second, and third embodiments have exemplified cardiovascular volume data obtained by CT. However, the present invention is not limited to the heart and can be applied to any regions of the whole body. In addition, the present invention is not limited to blood vessels and can be applied to other luminal organs and the like.

In addition, the present invention is not limited to CT image data and can be applied to volume data obtained by the X-ray diagnosis apparatus. Volume data obtained by an X-ray imaging apparatus, in particular, can be created during a medical treatment, and hence is often superior to CT image data.

Furthermore, the present invention is not limited to CT image data and can be applied to any of MRI data, PET data, and the like as long as it is 3D data.

### (Modification 2)

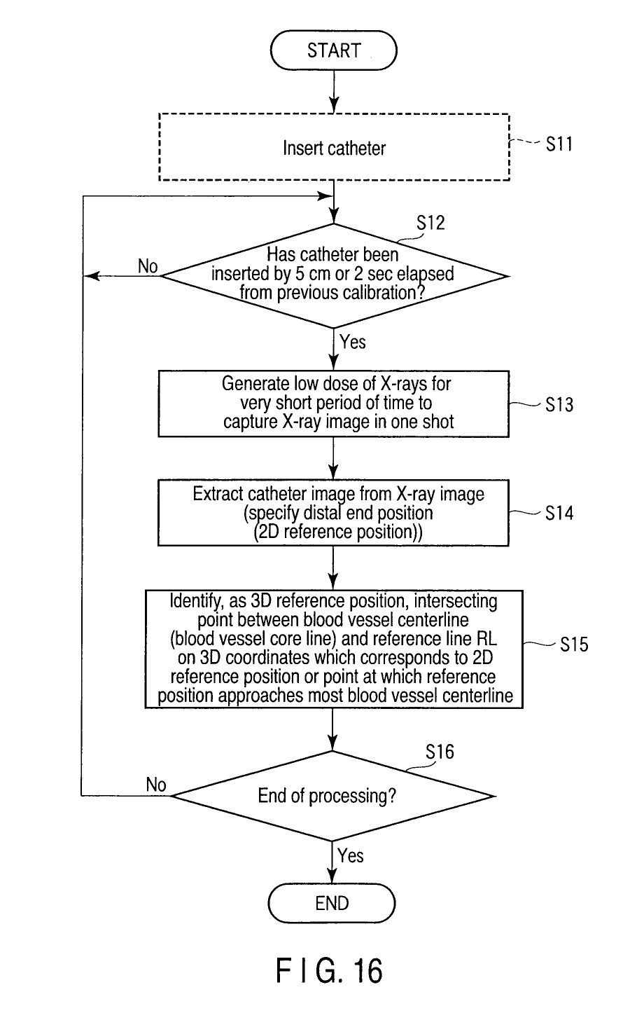

As shown in FIG. 16, the operator repeatedly calibrates a reference position throughout a period in which he/she executes catheterization (S11). This operation is effective in preventing a cumulative increase in error between the actual position (current position) of the catheter distal end and the position of the catheter distal end recognized on a 3D image on the apparatus side.

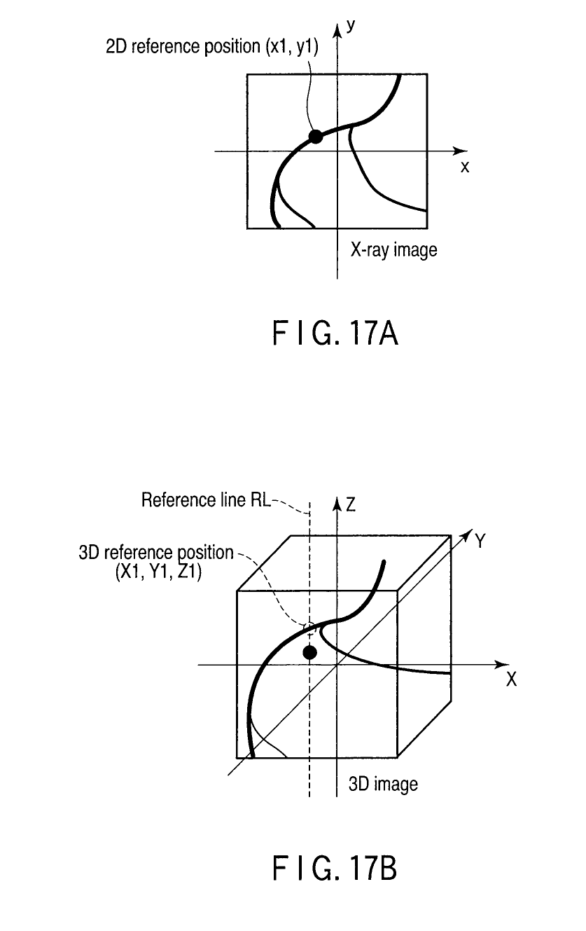

Calibration processing is performed under the control of the control unit 12 when the catheter is inserted by a predetermined distance, e.g., 5 cm, relative to the position at the time of the previous calibration processing or a predetermined period of time, e.g., 2 sec, has elapsed since the previous calibration processing (S12). In calibration processing, the X-ray diagnosis apparatus 30 actually irradiates an object with X-rays for a very short period of time, and the two-dimensional X-ray image 48 is obtained in one shot (S13). A computation unit 5 extracts a catheter image from the acquired two-dimensional X-ray image 48 by image extraction processing. As shown in FIG. 17A, the distal end position of the extracted catheter image is then specified as an actual reference position on two-dimensional coordinates (S14). This apparatus then identifies, as a new reference position on three-dimensional coordinates, the intersecting point between a blood vessel centerline and a reference line RL on three-dimensional coordinates which expresses a three-dimensional image acquired by the CT apparatus 20, with the intersecting point corresponding to the specified actual reference position on two-dimensional coordinates, or a point on a blood vessel centerline at which the blood vessel centerline approaches most the reference line RL (S15). The apparatus repeats the processing in S12 to S16 until the end of the catheterization (S16). Note that it suffices to automatically specify a two-dimensional reference position (catheter distal end position) in image processing as described above or manually designate a two-dimensional reference position by displaying an acquired X-ray image on the display unit.

In order to associate the two-dimensional X-ray image 48 in S15 with the three-dimensional image data acquired by the CT apparatus 20, it suffices to associate the direction of the C-arm 33 of the two-dimensional X-ray image 48, and the direction of the three-dimensional image data in advance.

The present invention can be applied to a medical image processing apparatus and X-ray diagnosis apparatus suitable for supporting catheterization and the like.

What is claimed is:

1. A medical image processing apparatus comprising:
an image storage unit which stores data of a three-dimensional image associated with an object receiving an operation using a lumen insertion device;
a lumen detection unit which detects a lumen line representing a run state of a lumen from the three-dimensional image;
a current position specifying unit which specifies a current position of the lumen insertion tube based on an insertion distance from a reference position associated with the lumen insertion device and the detected lumen line;
a cross-sectional image generating unit which creates data of a cross-sectional image associated with a cross-section passing through at least one of the current position on the lumen line, a position ahead of the current position, and a position behind the current position from data of the three-dimensional image; and
a display unit which displays the created data of the cross-sectional image.

2. The medical image processing apparatus according to claim 1, further comprising a distance measuring unit which measures an insertion distance of the lumen insertion device.

3. The medical image processing apparatus according to claim 2, wherein the distance measuring unit measures a moving distance of the lumen insertion device outside a body of the object.

4. The medical image processing apparatus according to claim 2, wherein
the lumen insertion device has scale marks formed thereon, and
the distance measuring unit includes a sensor which detects the sale marks and generates pulses, a counter which counts the pulses, and a distance specifying unit which specifies the insertion distance from the reference position based on the number of pulses counted.

5. The medical image processing apparatus according to claim 2, wherein the distance measuring unit includes a rotary encoder which operates in conjunction with movement of the lumen insertion device.

6. The medical image processing apparatus according to claim 2, wherein the lumen insertion device comprises forceps, catheter, or guide wire.

7. The medical image processing apparatus according to claim 1, further comprising:
an image acquisition unit which acquires data of a two-dimensional image; and
a reference position specifying unit which specifies, as the reference position, a position of the lumen insertion device on a two-dimensional image including an image associated with the lumen insertion device, based on a user instruction or an image of the lumen insertion device extracted from the two-dimensional image by image processing.

8. The medical image processing apparatus according to claim 7, wherein the reference position specifying unit repeatedly calibrates the reference position when the lumen insertion device has moved from previous calibration processing by a predetermined distance or a predetermined period has elapsed since the previous calibration processing.

9. The medical image processing apparatus according to claim 7, wherein the reference position specifying unit specifies a three-dimensional reference position on the lumen centerline which corresponds to the reference position.

10. The medical image processing apparatus according to claim 1, further comprising a marker superimposing unit which superimposes a marker indicating a current position of the lumen insertion device on a medical image including the specific lumen which is stored in the image storage unit together with the data of the three-dimensional image,
wherein the display unit displays the medical image on which the marker is superimposed, together with the generated cross-sectional image.

11. An X-ray diagnosis apparatus comprising:
an X-ray tube;
an X-ray detector;
an image storage unit which stores data of a three-dimensional image associated with an object receiving an operation using a lumen insertion device;
a lumen detection unit which detects a lumen centerline associated with a specific lumen from the three-dimensional image;
a distance measuring unit which repeatedly measures an insertion distance of the lumen insertion device;
a current position specifying unit which repeatedly specifies a current position of the lumen insertion device based on the measured insertion distance of the lumen insertion device and the detected lumen centerline;
a cross-sectional image generating unit which repeatedly generates data of a cross-sectional image associated with a cross-section passing through at least one of the current position on the lumen line, a position ahead of the current position, and a position behind the current position from the data of the three-dimensional image; and
a display unit which displays the generated data of the cross-sectional image.

12. The X-ray diagnosis apparatus according to claim 11, further comprising a distance measuring unit which measures an insertion distance of the lumen insertion device.

13. The X-ray diagnosis apparatus according to claim 12, wherein the distance measuring unit measures a moving distance of the lumen insertion device outside a body of the object.

14. The X-ray diagnosis apparatus according to claim 12, wherein
the lumen insertion device has scale marks formed thereon, and
the distance measuring unit includes a sensor which detects the sale marks and generates pulses, a counter which counts the pulses, and a distance specifying unit which specifies the insertion distance from the reference position based on the number of pulses counted.

15. The X-ray diagnosis apparatus according to claim 12, wherein the distance measuring unit includes a rotary encoder which operates in conjunction with movement of the lumen insertion device.

16. The X-ray diagnosis apparatus according to claim 12, wherein the lumen insertion device comprises forceps, catheter, or guide wire.

17. The X-ray diagnosis apparatus according to claim 11, further comprising a reference position specifying unit which specifies, as the reference position, a position of the lumen insertion device on a two-dimensional image including an image associated with the lumen insertion device, based on a user instruction or an image of the lumen insertion device extracted from the two-dimensional image by image processing.

18. The X-ray diagnosis apparatus according to claim 17, further comprising an image acquisition unit which acquires data of a two-dimensional image,
wherein the reference position specifying unit repeatedly calibrates the reference position when the lumen insertion device has moved from previous calibration processing by a predetermined distance or a predetermined period has elapsed since the previous calibration processing.

19. The X-ray diagnosis apparatus according to claim 17, wherein the reference position specifying unit specifies a three-dimensional reference position on the lumen centerline which corresponds to the reference position.

20. The X-ray diagnosis apparatus according to claim 11, further comprising a marker superimposing unit which superimposes a marker indicating a current position of the lumen insertion device on a medical image including the specific lumen which is stored in the image storage unit together with the data of the three-dimensional image,
wherein the display unit displays the medical image on which the marker is superimposed, together with the generated cross-sectional image.
